(19) United States
(12) Patent Application Publication
(10) Pub. No.: US 2018/0173235 A1
(43) Pub. Date: Jun. 21, 2018

(54) DRONE FOR AUTONOMOUSLY COMPLETING A TASK

(71) Applicant: Wal-Mart Stores, Inc., Bentonville, AR (US)

(72) Inventors: Donald R. High, Noel, MO (US); David C. Winkle, Bella Vista, AR (US); Michael D. Atchley, Springdale, AR (US); Brian G. McHale, Chadderton Oldham (GB); Nicholas Ray Antel, Springdale, AR (US); John J. O'Brien, Farmington, AR (US); Todd D. Mattingly, Bentonville, AR (US)

(21) Appl. No.: 15/851,455

(22) Filed: Dec. 21, 2017

Related U.S. Application Data
(60) Provisional application No. 62/437,188, filed on Dec. 21, 2016.

(51) Int. Cl. G05D 1/00; B64C 39/02

(52) U.S. Cl. CPC G05D 1/0088; B64C 39/024; B64C 2201/146; B64C 2201/141; B64C 2201/108; B64C 2201/126

(57) ABSTRACT

In some embodiments, apparatuses and methods are provided herein useful to autonomously completing a task. In some embodiments, a drone comprises a propulsion mechanism, an attachment point configured to releasably receive and secure at least one tool to the drone, a plurality of sensors configured to detect information regarding a performance of the task by the drone when a particular tool is secured to the attachment point, and a control circuit configured to receive the information regarding the performance of the task by the drone, determine that the performance of the task is inadequate, and in response to a determination that the performance of the task is inadequate, at least one of (a) select a new tool with which to perform the task to replace the particular tool and (b) transmit a notification indicating that a new drone is needed to perform the task using the particular tool.

### CROSS-REFERENCE TO RELATED APPLICATION

This application claims the benefit of U.S. Provisional Application No. 62/437,188, filed Dec. 21, 2016, which is incorporated by reference in its entirety herein.

### TECHNICAL FIELD

This invention relates generally to drones and, more specifically, to service drones.

### BACKGROUND

As everyday life gets busier and busier for many people, automated solutions to everyday tasks can provide relief. For example, if everyday chores were completed by automated systems, people would have more time to partake in activities that they enjoy. While some automated devices exist (e.g., vacuum systems), these devices are extremely task-specific and thus provide little or no versatility. Additionally, these automated devices, also referred to as drones, are not capable of monitoring the performance of tasks completed by the drones. Consequently, a need exists for more advanced systems that can provide tools for, and adapt to, a large variety of tasks while monitoring the performance of the tasks.

### BRIEF DESCRIPTION OF THE DRAWINGS

Disclosed herein are embodiments of systems, apparatuses and methods pertaining selecting tools and drones for completing a task. This description includes drawings, wherein:

FIGS. 1A and 1B depict a drone 100 for autonomously completing a task, according to some embodiments;

FIG. 2 depicts an example vehicle 210 for transporting drones, according to some embodiments;

FIG. 3 is a block diagram of a drone 302 for autonomously completing a task, according to some embodiments; and

FIG. 4 is a flow chart depicting example operations for autonomously completing a task with a drone, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to autonomously completing a task. In some embodiments, a drone for autonomously completing a task comprises a propulsion mechanism configured to move the drone without assistance, an attachment point, the attachment point configured to releasably receive and secure at least one tool to the drone, a plurality of sensors, the plurality of sensors configured to detect information regarding a performance of the task by the drone when a particular tool is secured to the attachment point, and a control circuit, the control circuit communicatively coupled to the plurality of sensors and configured to, receive, from the plurality of sensors, the information regarding the performance of the task by the drone using the particular tool, determine, based on the information regarding the performance of the task by the drone using the particular tool, that the performance of the task is inadequate, and in response to a determination that the performance of the task is inadequate, at least one of (a) select a new tool with which to perform the task to replace the particular tool and (b) transmit a notification indicating that a new drone is needed to perform the task using the particular tool.

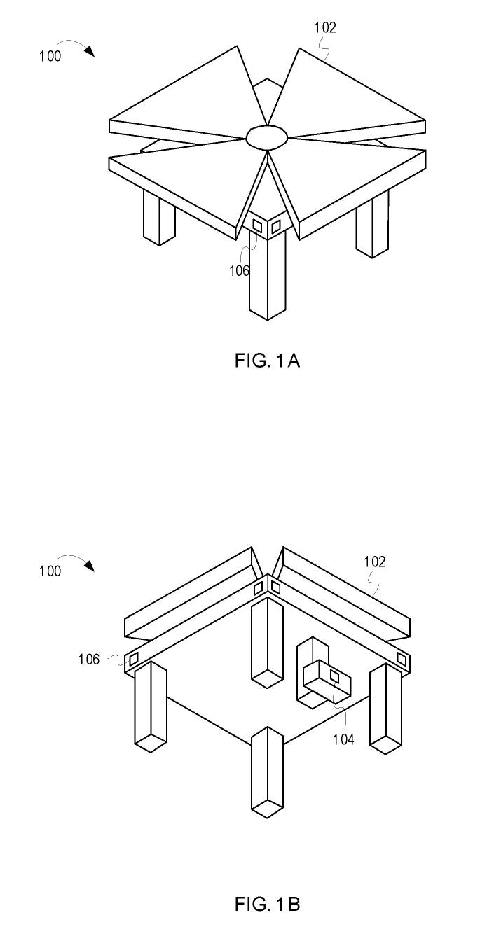

As previously discussed, while some automated devices, also referred to as drones, exist for autonomously preforming tasks, these devices are not capable of adapting to a wide range of tasks and cannot monitor performance of the tasks while the tasks are being completed. Consequently, a need exists for more advanced systems that can provide tools for, and adapt to, a large variety of tasks while monitoring the performance of the tasks. Embodiments of the systems, methods, and apparatuses described herein seek to meet this need by providing a drone that is adaptable to perform a variety of tasks and that can monitor the performance of the tasks as the drone completes the tasks. Further, in some embodiments, if the drone determines that the task is being performed inadequately, the drone can select a new tool with which to perform the task and/or transmit a notification indicating that a new drone is needed to perform the task. The discussion of FIGS. 1A and 1B provides an overview of an example drone that is capable of being adapted to perform a variety of tasks and monitoring performance of the tasks as the drone completes the task.

FIGS. 1A and 1B depict a drone 100 for autonomously completing a task, according to some embodiments. The drone 100 depicted in FIGS. 1A and 1B is an example of an autonomous device that is capable of being adapted to perform a variety of tasks and monitoring performance of the tasks as the drone 100 completes the tasks. While the drone 100 depicted in FIGS. 1A and 1B is an aerial drone 100, other types of drones (e.g., terrestrial drones and aquatic drones) can be configured to be capable of being adapted to perform a variety of tasks and monitoring performance of the tasks as the drone completes the tasks.

The drone 100 includes a propulsion mechanism 102. The propulsion mechanism 102 is capable of moving the drone 100 without assistance. As the drone 100 depicted in FIGS. 1A and 1B is an aerial drone 100, the propulsion mechanism 102 is a propeller mechanism suitable for aerial flight. Different types of autonomous devices may have different types of propulsion mechanisms, or multiple types of propulsion mechanisms, dependent upon the specific type of autonomous device. For example, a terrestrial drone may have a propulsion mechanism that includes a motor, transmission, and wheels. The propulsion mechanism 102 moves the drone 100 as the drone completes tasks, such as painting, trimming, cleaning, surveilling, etc. The drone 100 is capable of performing such a wide range of tasks because it is capable of being equipped with a wide variety of tools. The drone 100 depicted in FIGS. 1A and 1B, includes an attachment point 104 that is capable of releasably receiving and securing one or more tools. The attachment point 104 can be designed to accept modular tools or reconfigurable so that the attachment point 104 can accept a variety of tools. Although the drone 100 depicted in FIGS. 1A and 1B includes only a single attachment point 104, in some embodiments, the drone 100 can include multiple attachment points. For example, the drone 100 may include a first attachment point that extends away from the drone 100 in a horizontal direction (e.g., like the attachment point 104) as well as an attachment point that extends away from the drone 100 in a vertical (e.g., downward or upward) direction. The multiple attachment points can be designed for different tools or for use during the completion of different tasks.

The drone 100 also includes sensors 106. The drone 100 uses the sensors 106 to monitor performance of tasks. The performance of the task can be based on a variety of factors: 1) the quality of the performance of the task (e.g., whether the task is being performed adequately), 2) a speed of the performance of the task (whether the task is being completed quickly or slowly enough), 3) changed instructions (e.g., if a customer has changed or modified the tasks to be performed and/or how the tasks should be performed), 4) environmental impact (e.g., whether performance of the task is resulting in an undesired impact on the drone's 100 surroundings), 5) environmental conditions (e.g., changing weather conditions), 6) or any other suitable factor. Additionally, the sensors 106 can monitor the quality and/or condition of the tools (e.g., if the tool is broken, dull, unbalanced, etc.). Accordingly, the sensors 106 can be of any suitable type. For example, the sensors 106 can include image sensors, auditory sensors, pressure sensors, weight sensors, proximity sensors, rotation sensors, location sensors, light sensors, radar sensors, temperature sensors, power sensors, voltage sensors, and vibration sensor, etc.

If the drone 100 determines that the performance of the task is inadequate (i.e., the drone's 100 performance of the task is not consistent with any conditions, instructions, etc.), the drone 100 will attempt to remedy the inadequacy. For example, if the drone 100 is capable of performing the task adequately if a different tool is used, the drone 100 can select a new tool with which to perform the task (e.g., the tool is too dull or the wrong tool is being used). As another example, if the drone 100 is incapable of performing the task, the drone can transmit a notification indicating that a new drone is needed to perform the task (i.e., the new drone can perform the task alone or in concert with the drone 100). Further, in some embodiments, the drone 100 can select the new drone.

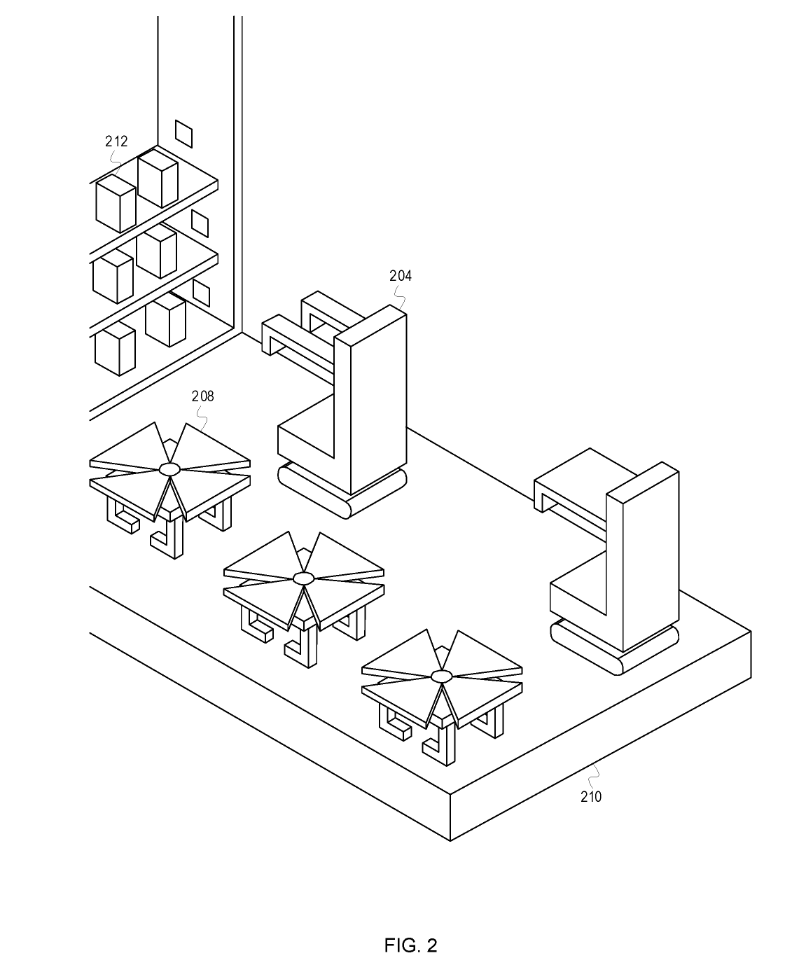

While the discussion of FIGS. 1A and 1B provide background information regarding a drone that is capable of being adapted to perform a variety of tasks and monitoring performance of the tasks as the drone completes the tasks, the discussion of FIG. 2 provides additional information regarding such drones and an example vehicle for transporting such drones.

FIG. 2 depicts an example vehicle 210 for transporting drones, according to some embodiments. The vehicle 210 depicted in FIG. 2 is transporting aerial drones 208 and terrestrial drones 204. In some embodiments, the vehicle 210 is capable of transporting the drones autonomously. Additionally, the vehicle 210 can provide power to the drones and house tools 212 for use by the drones. The drones equip themselves with tools 212 by retrieving one or more of the tools 212 and securing the one or more tools 212 to themselves.

In some embodiments, the vehicle 210 selects which drones will perform the tasks. That is, the vehicle 210 includes the necessary hardware and software to review the tasks and determine which drones are available and suited to perform the tasks. In such embodiments, if the drone selected to perform the task determines that the performance of the task is inadequate, the drone can transmit a notification indicating the inadequacy of the performance to the vehicle 210. For example, if a new drone is needed to complete the task, the drone can transmit a notification to the vehicle 210 indicating that a new drone is needed to complete the task. In such embodiments, the vehicle 210 can select the new drone and notify the new drone of the task. Alternatively, the drone can select the new drone and transmit a notification to the new drone indicating that the new drone is needed to complete the task. Upon selection of the new drone, the drone provides the tool to the new drone.

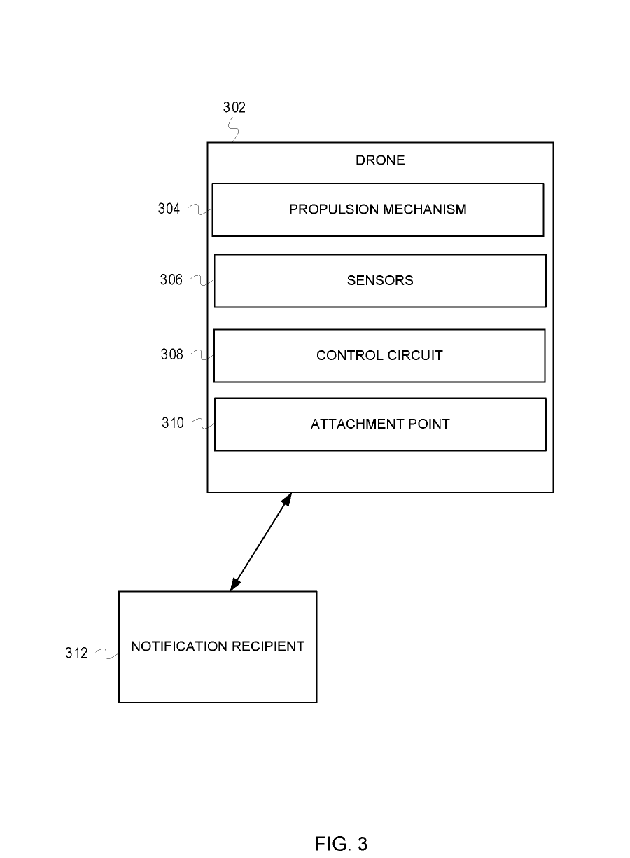

While the discussion of FIG. 2 provides additional information regarding such drones and an example vehicle for transporting such drones, the discussion of FIG. 3 provides additional information regarding a drone that is capable of being adapted to perform a variety of tasks and monitoring performance of the tasks as the drone completes the tasks.

FIG. 3 is a block diagram of a drone 302 for autonomously completing a task, according to some embodiments. The drone 302 includes a propulsion mechanism 304, sensors 306, a control circuit 308, and an attachment point 310. The control circuit 208 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 308 is configured (for example, by using corresponding programming as will be well understood by those skilled in the art) to carry out one or more of the steps, actions, and/or functions described herein.

By one optional approach the control circuit 308 operably couples to a memory. The memory may be integral to the control circuit 308 or can be physically discrete (in whole or in part) from the control circuit 308 as desired. This memory can also be local with respect to the control circuit 308 (where, for example, both share a common circuit board, chassis, power supply, and/or housing) or can be partially or wholly remote with respect to the control circuit 308 (where, for example, the memory is physically located in another facility, metropolitan area, or even country as compared to the control circuit 308).

This memory can serve, for example, to non-transitorily store the computer instructions that, when executed by the control circuit 308, cause the control circuit 308 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The attachment point 310 is configured to secure tools to the drone 302. The attachment point 302 can be designed such that it is compatible with tools based on a modular design (e.g., a proprietary design or based on industry standards) or can be configured to be adjustable so as to accommodate a wide variety of tools. Although FIG. 3 depicts the drone 302 as including only one attachment point, embodiments are not so limited and the drone 202 can include multiple attachment points 304. The multiple attachment points can be configured to accommodate different tools or different types of tools, oriented in different directions, configured to accommodate a different number of tools, etc.

The propulsion mechanism 304 is configured to move the drone 302. The propulsion mechanism 304 can be any suitable type of propulsion mechanism 304 and can be based on the type of the drone 302. For example, if the drone 302 is capable of traveling both by air and by water, the drone 302 may include two propulsion mechanism (i.e., a propulsion mechanism 304 adapted for travelling by air and a propulsion mechanism adapted for travelling by water). In some embodiments, the drone 302 is capable of travelling without human intervention (autonomously) and/or under human control (remote-controlled). The propulsion mechanism 304 can propel the drone 302 while the drone 302 is performing tasks as well as propel the drone 302 to and from locations at which the drone 302 performs tasks.

The control circuit 308 monitors the performance of the task by the drone 302. The performance of the task can be based on a variety of factors: 1) the quality of the performance of the task (e.g., whether the task is being performed adequately), 2) a speed of the performance of the task (whether the task is being completed quickly or slowly enough), 3) changed instructions (e.g., a customer has changed or modified the tasks to be performed and/or how the tasks should be performed), 4) environmental impact (e.g., whether performance of the task is resulting in an undesired impact on the drone's 302 surroundings), 5) environmental conditions (e.g., changing weather conditions), 6) or any other suitable factor. If the performance of the task is inadequate, the drone 302 will attempt to remedy the inadequacy. For example, if the drone 302 is capable of performing the task adequately if a different tool is used, the drone 302 can select a new tool with which to perform the task. Additionally, in some embodiments, the drone 302 can cause the new tool to be releasably secured to the attachment point 310.

As another example, if the drone 302 is incapable of performing the task, the drone can transmit a notification indicating that a new drone is needed to perform the task (i.e., the new drone can perform the task alone or in concert with the drone 302). The drone 302 can transmit the notification indicating that a new drone is needed to perform the task to a notification recipient 312. The notification recipient 312 can be the new drone, a backend device (e.g., a scheduling server), and/or a vehicle transporting the drone 302. In some embodiments, the notification includes an indication of why the performance of the task by the drone was inadequate. Further, if the drone 302 transmits a notification indicating that a new drone is needed to perform the task, the notification can include an indication of why the drone's 302 performance of the task was inadequate. In some embodiments, when a new drone is selected, the drone 302 unsecures the tool from the attachment point 310 and provides the tool to the new drone.

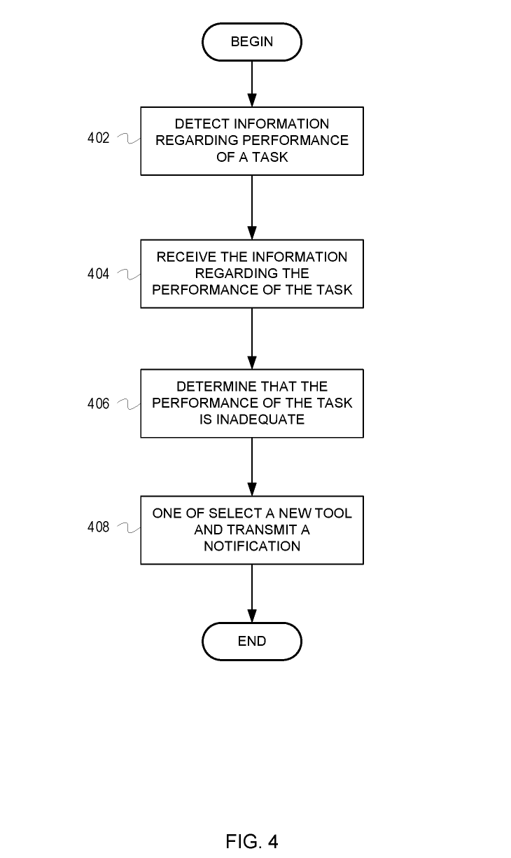

While the discussion of FIG. 3 provides additional information about a drone that is capable of being adapted to perform a variety of tasks and monitoring performance of the tasks as the drone completes the tasks, the discussion of FIG. 4 describes example operations monitoring performance of the tasks as the drone completes the tasks.

FIG. 4 is a flow chart depicting example operations for autonomously completing a task with a drone, according to some embodiments. The flow begins a block 402.

At block 402, information regarding performance of a task is detected. For example, a plurality of sensors associated with a drone can detect information regarding performance of the task. The sensors can be of any suitable type. For example, the sensors can include image sensors, auditory sensors, pressure sensors, weight sensors, proximity sensors, rotation sensors, location sensors, light sensors, radar sensors, temperature sensors, power sensors, voltage sensors, and vibration sensor, etc. The flow continues at block 404.

At block 404, the information regarding the performance of the task is received. For example, a control circuit can receive the information regarding the performance of the task. The control circuit can be located locally or remotely from the drone. That is, the control circuit can be a part of the drone or part of a system that is separate from the drone. The flow continues at block 406.

At block 406, it is determined that the performance of the task is inadequate. For example, the control circuit can determine that the performance of the task is inadequate. The performance of the task can be based on a variety of factors: 1) the quality of the performance of the task (e.g., whether the task is being performed adequately), 2) a speed of the performance of the task (whether the task is being completed quickly or slowly enough), changed instructions (e.g., a customer has changed or modified the tasks to be performed and/or how the tasks should be performed), 3) environmental impact (e.g., whether performance of the task is resulting in an undesired impact on the drone's surroundings), 4) environmental conditions (e.g., changing weather conditions), 5) or any other suitable factor. The flow continues at block 408.

At block 408, one of new tool is selected and a notification is transmitted. For example, the control circuit can one of select a new tool with which the drone will complete the task and transmit a notification indicating that a new drone is needed to complete the task. If a new tool is needed, the drone can unsecure the current (particular) tool and secure the new tool. If a new drone is needed, the drone can unsecure the current (particular) tool and autonomously provide the current (particular) tool to the new drone. If the drone is incapable of completing the task such that a new drone is needed, the drone can transmit a notification indicating that a new drone is needed to a vehicle carrying the drone and/or a backend server. Additionally, in some embodiments the drone can select a new drone to perform the task and transmit the notification to the new drone.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

Generally speaking, pursuant to various embodiments, systems, apparatuses, and methods are provided herein useful to autonomously completing a task. In some embodiments, a drone for autonomously completing a task comprises a propulsion mechanism configured to move the drone without assistance, an attachment point, the attachment point configured to releasably receive and secure at least one tool to the drone, a plurality of sensors, the plurality of sensors configured to detect information regarding a performance of the task by the drone when a particular tool is secured to the attachment point, and a control circuit, the control circuit communicatively coupled to the plurality of sensors and configured to, receive, from the plurality of sensors, the information regarding the performance of the task by the drone using the particular tool, determine, based on the information that the performance of the task is inadequate, and in response to a determination that the performance of the task is inadequate, at least one of (a) select a new tool with which to perform the task to replace the particular tool and (b) transmit a notification indicating that a new drone is needed to perform the task using the particular tool.

In some embodiments, an apparatus and a corresponding method performed by the apparatus comprises detecting, via a plurality of sensors, information regarding a performance of the task by the drone using a particular tool, receiving, from the plurality of sensors, the information regarding the performance of the task by the drone using the particular tool, determining, based on the information regarding the performance of the task by the drone using the particular tool, that the performance of the task by the done using the particular tool is inadequate, and in response to determining that the performance of the task by the drone using the particular tool is inadequate, at least one of (a) selecting a new tool with which to perform the task to replace the particular tool and (b) transmitting a notification indicating that a new drone is needed to perform the task using the particular tool, wherein the drone includes an attachment point configured to releasably receive and secure at least on tool to the drone.

What is claimed is:

1. A drone for autonomously completing a task, the drone comprising:
a propulsion mechanism configured to move the drone without assistance;
an attachment point, the attachment point configured to releasably receive and secure at least one tool to the drone;
a plurality of sensors, the plurality of sensors configured to detect information regarding a performance of the task by the drone when a particular tool is secured to the attachment point; and
a control circuit, the control circuit communicatively coupled to the plurality of sensors and configured to:
receive, from the plurality of sensors, the information regarding the performance of the task by the drone using the particular tool;
determine, based on the information regarding the performance of the task by the drone using the particular tool, that the performance of the task is inadequate; and
in response to a determination that the performance of the task is inadequate, at least one of (a) select a new tool with which to perform the task to replace the particular tool and (b) transmit a notification indicating that a new drone is needed to perform the task using the particular tool.

2. The drone of claim 1, wherein the determination that the performance of the task by the drone using the particular tool is inadequate is based on one or more of a quality of the performance of the task, a speed of the performance of the task, changed instructions, environmental impact, and environmental conditions.

3. The drone of claim 1, wherein the plurality of sensors includes one or more of image sensors, auditory sensors, pressure sensors, weight sensors, proximity sensors, rotation sensors, location sensors, light sensors, radar sensors, temperature sensors, power sensors, voltage sensors, and vibration sensor.

4. The drone of claim 1, wherein the attachment point is configured to releasably receive and secure modular tools.

5. The drone of claim 1, wherein the notification includes an indication of why the performance of the task by the drone using the particular tool is inadequate.

6. The drone of claim 1, wherein the control circuit is further configured to:
in response to selection of a new tool, cause the new tool to be releasably secured to the attachment point.

7. The drone of claim 1, wherein the control circuit is further configured to:
in response to transmission of the notification indicating that a new drone is needed to perform the task, cause the attachment point to unsecure the particular tool; and
provide, to the new drone, the particular tool.

8. The drone of claim 1, wherein the new drone works cooperatively with the drone.

9. The drone of claim 1, wherein the control circuit causes the notification indicating that a new drone is needed to perform the task is transmitted to the new drone.

10. A method for autonomously completing a task with a drone, the method comprising:
detecting, via a plurality of sensors, information regarding a performance of the task by the drone using a particular tool;
receiving, from the plurality of sensors, the information regarding the performance of the task by the drone using the particular tool;
determining, based on the information regarding the performance of the task by the drone using the particular tool, that the performance of the task by the drone using the particular tool is inadequate; and
in response to determining that the performance of the task by the drone using the particular tool is inadequate, at least one of (a) selecting a new tool with which to perform the task to replace the particular tool and (b) transmitting a notification indicating that a new drone is need to perform the task using the particular tool;
wherein the drone includes an attachment point configured to releasably receive and secure at least one tool to the drone.

11. The method of claim 10, wherein the determining that the performance of the task by the drone is inadequate based on one or more of a quality of the performance of the task, a speed of the performance of the task, changed instructions, environmental impact, and environmental conditions.

12. The method of claim 10, wherein the plurality of sensors includes one or more of image sensors, auditory sensors, pressure sensors, weight sensors, proximity sensors, rotation sensors, location sensors, light sensors, radar sensors, temperature sensors, power sensors, voltage sensors, and vibration sensor.

13. The method of claim 10, wherein the attachment point is configured to releasably receive and secure modular tools.

14. The method of claim 10, wherein the notification includes an indication of why the performance of the task by the drone is inadequate.

15. The method of claim 10, further comprising:
in response to selecting a new tool, causing the new tool to be releasably secured to the attachment point.

16. The method of claim 10, further comprising:
in response to transmitting the notification indicating that a new drone is needed to perform the task, causing the attachment point to unsecure the particular tool; and
providing, to the new drone, the particular tool.

17. The method of claim 10, wherein the new drone works cooperatively with the drone.

18. The method of claim 10, wherein the notification indicating that a new drone is needed to perform the task is transmitted to the new drone.
